(19) United States
(12) Patent Application Publication
(10) Pub. No.: US 2024/0280527 A1
(43) Pub. Date: Aug. 22, 2024

(54) Humidity Sensor

(71) Applicant: TE Connectivity Sensors France, Toulouse (FR)

(72) Inventors: Fabien Gayrard, Toulouse (FR); Quentin Fraisse, Toulouse (FR)

(73) Assignee: TE Connectivity Sensors France, Toulouse (FR)

(21) Appl. No.: 18/443,412

(22) Filed: Feb. 16, 2024

(30) Foreign Application Priority Data
Feb. 17, 2023 (EP) 23305213.3

(51) Int. Cl. G01N 27/22

(52) U.S. Cl. CPC G01N 27/225

(57) ABSTRACT

A humidity sensor includes a sensing element and a switching device. The sensing element has a first electrode, a second electrode, and a moisture-sensitive element. A portion of the moisture-sensitive element is sandwiched between the first electrode and the second electrode. The switching device switches the first electrode between a first state of operation and a second state of operation. The first electrode senses an electric property of the moisture-sensitive element in the first state of operation. The first electrode heats the moisture-sensitive element with an electric current through the first electrode in the second state of operation.

### CROSS-REFERENCE TO RELATED APPLICATIONS

This application claims the benefit of the filing date under 35 U.S.C. § 119(a)-(d) of European Patent Application No. 23305213.3, filed on Feb. 17, 2023.

### FIELD OF THE INVENTION

The present invention relates to a humidity sensor including a sensing element with a first electrode, a second electrode and a moisture-sensitive element.

### BACKGROUND

Humidity sensors are known in the art in which two electrodes are arranged to monitor variations in an electric property of a moisture-sensitive element operating as a dielectric. For example, it is known to measure the capacitance of a polymer layer arranged between the electrodes that is in gaseous exchange with an ambient environment and use the capacitance measure to determine the relative humidity (RH) of the environment. One such capacitive sensor is described in EP 2 755 023 A1. Another such capacitive sensor is described in WO 2001/042776 A1.

According to a phenomenon known as creep, or positive RH offset or positive RH shift, some of the water molecules having diffused from the environment into the polymer layer create bonds and become trapped in the polymer structure. The effect is particularly prevalent after prolonged exposure in high-temperature, high-humidity environments and risks a permanent distortion of the measurement. In particular, the creep effect may lead to wrongly inflated values, reducing humidity sensor performance and limiting recommended operating conditions.

Therefore, humidity sensors in the art include additional heating devices to heat the moisture-sensitive element, but their heating performance is limited by insulating barrier elements interposed between said devices and the moisture-sensitive element.

### SUMMARY

A humidity sensor includes a sensing element and a switching device. The sensing element has a first electrode, a second electrode, and a moisture-sensitive element. A portion of the moisture-sensitive element is sandwiched between the first electrode and the second electrode. The switching device switches the first electrode between a first state of operation and a second state of operation. The first electrode senses an electric property of the moisture-sensitive element in the first state of operation. The first electrode heats the moisture-sensitive element with an electric current through the first electrode in the second state of operation.

### BRIEF DESCRIPTION OF THE DRAWINGS

The invention will be described in more detail in the following with reference to exemplary embodiments illustrated in the drawings, in which:

FIG. 1A shows a cross-sectional side view of a humidity sensor according to a first embodiment of the invention.;

FIG. 1B shows a cross-sectional top view of an electrode for the humidity sensor of FIG. 1A;

FIG. 2 shows a cross-sectional top view of an electrode for a humidity sensor according to a second embodiment of the invention;

FIG. 3A shows a cross-sectional top view of an electrode for a humidity sensor according to a third embodiment of the invention; and

FIG. 3B shows a cross-sectional side view of an electrode for the humidity sensor of FIG. 3A.

### DETAILED DESCRIPTION OF THE EMBODIMENT(S)

Aspects, objects, features and advantages of the present invention will be more completely understood and appreciated by careful study of the following more detailed description of exemplary aspects and embodiments of the invention, taken in conjunction with the accompanying drawings.

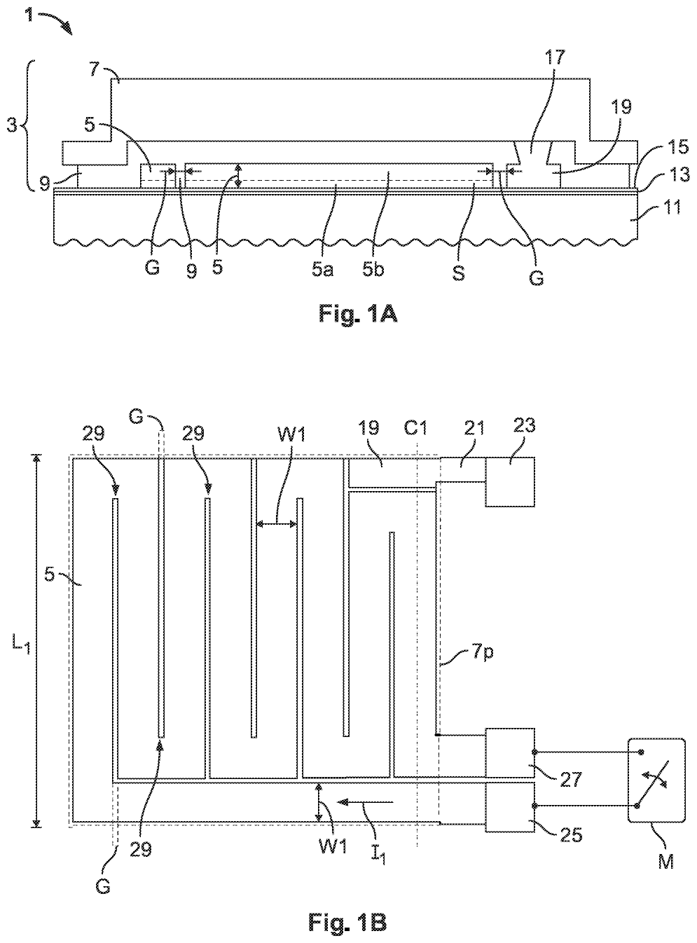

Unless explicitly described otherwise, the structural features of the objects illustrated in FIGS. 1A to 3B are not drawn to scale, neither individually with respect to their Cartesian dimensions, nor with respect to each other along one Cartesian direction. Identical reference signs used in different figures relate to identical elements.

A humidity sensor according to a first embodiment of the invention will now be described with reference to FIGS. 1A and 1B. FIG. 1A shows a cross-sectional side view of the humidity sensor 1 along the line C1 in FIG. 1B. The humidity sensor 1 of the first embodiment is a sandwich-type sensor. That is, the sensing element 3 of the sensor 1 comprises a first (“bottom”) electrode 5, a second (“top”) electrode 7, and a moisture-sensitive element 9 sandwiched by the first electrode 5 and the second electrode 7.

The humidity sensor 1 further comprises an application-specific integrated circuit (ASIC) 11 typically manufactured by complementary metal-oxide semiconductor (CMOS) technology. The ASIC 11 comprises an outermost passivation layer 13, which in one embodiment can be a silicon dioxide (SiO2) layer or a silicon nitride (Si3N4) or a bilayer of silicon dioxide (SiO2) over silicon nitride (Si3N4).

In the shown embodiment, the first electrode 5 is provided on the passivation layer 13, the moisture-sensitive element 9 is then provided on the first electrode 5, and the second electrode 7 is provided over the moisture-sensitive element 9. The second electrode 7 is deposited such that it fully overlays both the first electrode 5 and the moisture-sensitive element 9, without contacting the first electrode 5. In this embodiment, a via 17 is additionally formed in the moisture-sensitive element 9, connecting the second electrode 7 to an internal contact pad 19.

The second electrode 7 is thicker than the first electrode 5, and porous, such that gas molecules of the ambient environment such as water can diffuse into the moisture-sensitive element 9. For example, the second electrode 7 can comprise an organic binder filled with platinum or carbon particles. In an embodiment, the second electrode 7 is more than two times thicker, or more than five times thicker. In one configuration, the second electrode 7 can have a thickness between 25 μm and 100 μm.

The second electrode 7 may be non-metallic. The second electrode 7 may comprise, in particular may be made of an organic material. The organic material may be an organic conductive polymer. The second electrode 7 may comprise, in particular may be made of, an Intrinsically Conductive Polymer (ICP), a phenolic resin, a vinyl polymer, a rubber, a fluoropolymer, a polyolefin, a polyester, a polyanhydride, a silicone, a biopolymer, an inorganic polymer, or a combination thereof. The material of the second electrode 7 may be doped with electrically conductive particles, in particular with carbon and/or platinum particles. In one configuration, the material may be electrically conductive with an electrical resistivity of 10 Ω·m to 50 Ω·m.

The second electrode 7 may be porous. The material of the second electrode 7 may be provided with a plurality of pores. A pore of the plurality of pores may have a size, in particular a diameter, comprised between 10 nm to 2000 nm.

In a variant of the first embodiment, the second electrode 7 may instead comprise, in particular be made of, a metallic material. The metallic material of the second electrode 7 may be aluminum, copper, gold, titanium, or an alloy thereof. The metallic second electrode may have a plurality of through-holes, or perforations. The through-holes are configured to expose a portion of the moisture-sensitive element to the ambient environment, to allow diffusion of gas molecules into the moisture-sensitive element. The through-holes may traverse a thickness of the second electrode 7 to create a channel exposing a portion of the moisture-sensitive element 9 to the ambient environment. In one configuration, the through-holes may be arranged as an array of circular through-holes. In another configuration, the through-holes may be arranged as slits extending along a planar extension of the moisture-sensitive element 9. A through-hole of the plurality of through-hole may have a greatest dimension comprised between 500 nm to 1000 nm.

The moisture-sensitive layer 9 comprises a dielectric material whose capacitance varies with the water content in the moisture-sensitive layer 9. In this embodiment, the moisture-sensitive element 9 is made of a polymeric material, specifically a polyimide. As will become clearer in view of FIG. 1B, the moisture-sensitive layer 9 fills gaps G in the first electrode 5 entirely such the dielectric material is directly in contact with a surface 15 both around the first electrode 5, and inside the gaps G.

The electrodes 5 and 7 are connected to ASIC input pads of the ASIC 11 by conventionally known techniques such as wire-bonding or metal traces. The ASIC 11 is configured to sense the capacitance and to output a corresponding signal. The packaging and over-molding of the sensing element 3 and the ASIC 11 can vary depending on application-specific requirements or manufacturing constraints, is known in the art, and will not be further described.

In alternative embodiments, the moisture-sensitive element 9 can be an inorganic layer. In further alternative embodiments, the dielectric material of the moisture-sensitive element 9 can be selected such that a different electric property, for example the resistance, impedance, or reactance, varies sensitively with the present water content.

According to a variant of the first embodiment of the invention, the first electrode 5 can be a bi-layer electrode having a first layer 5a formed on the surface 15 of the passivation layer 13, and a second layer 5b formed on the first layer 5a of the first electrode 5. For illustration purposes, the separation line S illustrates the demarcation between the first layer 5a and the second layer 5b.

The first layer 5a is a metallic layer of a material selected amongst tungsten (W), manganese (Mn), titanium (Ti), chrome (Cr), titanium nitride (TiN), and alloys thereof. These materials have good adhesion to the underlying passivation layer 13. In addition, those layers provide a higher resistivity, allowing a higher heat generation when an electric current flows through the first electrode 5. In variants, the second layer 5a can also be a carbon-based layer or a stainless-steel layer.

The second layer 5b is a metallic layer of a noble metal selected e.g., amongst gold (Au), platinum (Pt), copper (Cu), and silver (Ag). The second layer 5b is configured to prevent or reduce corrosion and to provide a high conductivity for improved capacitance sensing performance.

The first layer 5a and second layer 5b of the first electrode 5 can each have thicknesses comprised between 1 nm and 1000 nm, each between 10 nm and 200 nm. In an embodiment, the first layer 5a has a thickness between two and five times greater than the thickness of the second layer 5b.

The sensing element 3 can be formed on the surface 15 of the passivation layer 13 of the ASIC 11 using a microelectromechanical (MEMS) manufacturing process, e.g., using photolithography for patterning purposes.

FIG. 1B shows a cross-sectional top view of the first electrode 5 of the humidity sensor 1. In particular, FIG. 1B illustrates the first electrode 5, the internal contact pad 19 connected to the second electrode 7, as well as, for illustration purposes, the peripheral outline 7p of the active region of the porous second electrode 7 deposited over the first electrode 5, projected onto the same plane. In this embodiment, the second electrode 7 has a square shape, and the projection 7p is correspondingly square shaped as well. The line C1 represents the cut line for the cross-sectional view of FIG. 1A.

The internal contact pad 19 is connected by a metal trace 21 to an ASIC input pad 23 of the ASIC. The first electrode 5 has a serpentine shape and comprises, at respectively opposed extremities of the serpentine shape, a first contact pad 25, representing a first contact point, and a second contact pad 27, representing a second contact point. The contact points, here contact pads 25, 27, are configured for the application of an electrical potential therebetween. In this embodiment, the first contact pad 25 and the second contact pad 27 are directly connected to ASIC input pads by conventional techniques such as wire-bonding or metal tracing.

The first electrode 5 has a serpentine shape with square windings or turning portions. In other words, the first electrode 5 is a continuous conductive trace that goes back and forth, in the shape of a square saw-tooth signal shape. For example, in the present embodiment, the electrode 5 is patterned to a serpentine shape having at least five, for example seven, winding inflections 29, or inflection points, around which the continuous trace of the serpentine shape inflects. A serpentine shape provides for a larger ratio of electrode length (l) over cross-sectional area (A) in comparison to, for example, a plate-shaped electrode, at equivalent material quantity. Therefore, for a given material resistivity, the serpentine-shaped electrode has higher total resistance and can provide more heat.

The first electrode 5 is dimensioned and shaped to cover substantially the entirety of the area defined by the projection 7p, to maximize the capacitance of the sandwiched moisture-sensitive element 9 to be measured. For this purpose, the gap G between the windings, that is, between linear sections, of the serpentine shape is kept small, specifically at least five times smaller, than the cross-sectional width W1 of first electrode 5. As already mentioned, in this embodiment, the gap G is filled with the dielectric material of the moisture-sensitive element 9. However, according to variants, the gap G can also be filled with a different, insulating, non-conductive material. By keeping the gap as small compared to the width, the loss in capacitance of the moisture-sensitive element 9, in comparison with for example a plane plate-shaped first electrode, can be limited, and the measure of capacitance can be improved.

As the moisture-sensitive element 9 is deposited over the serpentine-shaped first electrode 5, the top and side surfaces of the first electrode 5 are covered by, that is, in contact with, the moisture-sensitive element 9, and the bottom surface is in contact with the surface 15 of the passivation layer 13. As already mentioned, the moisture-sensitive material 9 also fills the gap G between windings of the first electrode 5.

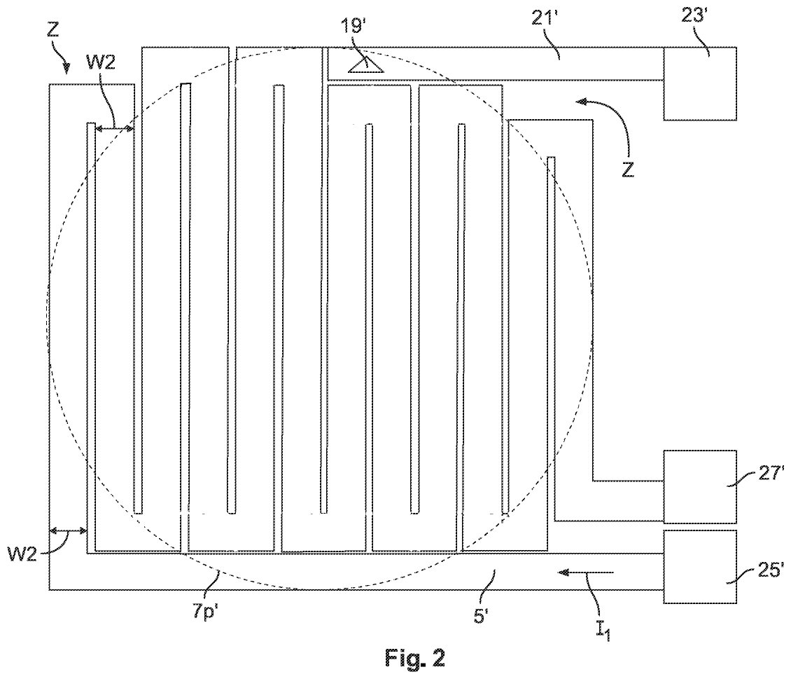

The projection 7p of the active region of the second electrode 7, representing substantially the area covered by the first electrode 5, has a square side length L1 having a value comprised between 10 μm and 5000 μm, or between 200 μm and 500 μm. In alternative embodiments, the projection of the second electrode 7 can be rectangular-shaped rather than square-shaped, or circular (see FIG. 2). The width W1 has a value comprised between 3 μm and 300 μm, or between 10 μm and 100 μm.

The gap G has a value between 0.6 μm and 60 μm. As dielectric material of the moisture-sensitive element 9 fills the gaps G, the nominal capacitance of the sensing element 3 is reduced and the sensitivity of the sensor 1 is reduced. Thus, keeping the gap G small provides the advantage of also keeping the loss in capacitance of the moisture-sensitive element 9 small, in comparison to a plate-shaped first electrode.

In a practical example, the gap G is 6 μm wide and the first electrode has a width W1 of 30 μm. In that case, a loss in capacitance of less than 2% can be observed compared to a plane plate-shaped electrode.

In this embodiment, the ASIC 11 is connected to contact pads 25, 27 of the first electrode 5 and to the second electrode 7 through the contact pad 23.

According to the invention, the ASIC 11 includes a switching device M, illustrated schematically on FIG. 1B. According to the present embodiment, the switching device M is not a hardware component but a process step or a programmed feature of the ASIC 11.

However, in variants, the switching device M can be a hardware component, such as a switch, included with the packaging of the humidity sensor 1, or a hardware component physically separate from the packaging of the humidity sensor 1. In a further variant, the switching device M can be a process step or a programmed feature of a physically separate processor. In these cases, the contact pads 25, 27 are connected to contact points of the external switching device M by wire-bonding or metal traces.

The switching device M is arranged to switch the first electrode 5 between a first state of operation and a second state of operation. In the first state of operation according to the invention, the electrical contact points of the contact pads 25, 27 of the first electrode 5 are short cut by the switching device M and thus at the same electrical potential. In this position, the capacitance of the moisture-sensitive element 9 can be sensed by the application of a voltage between the first electrode 5 and the second electrode 7. For example, the capacitance can be sensed by sigma-delta modulation. The capacitance measure can be used to derive a relative humidity (RH) value. No current flows through the electrode from one electrical contact point to the other electrical contact point in the first state of operation for the sensing of an electric property of the moisture-sensitive element 9.

In the second state of operation according to the invention, the contact pads 25, 27 of the first electrode 5 are not short-cut, and instead connected to different electric potentials such that an electric current I₁ flows through the serpentine-shaped first electrode 5. Thus, a direct electrical current can flow from one electrical contact point, for example contact pad 25, to the other electrical contact point for example contact pad 27 in the second state of operation.

The material and structural features of the first electrode 5 described here-above allow for an efficient heating of the moisture-sensitive element 9 through the current I ₁ flowing through the first electrode 5. For example, in the second state of operation, the electrical current can have a current intensity between 10 mA and 100 mA. In some embodiments, to avoid overheating of the electrode, the electrical current in the second state of operation can be controlled to flow in pulses, for example in pulses of a duration comprised between 0.1 s and 1 s.

When the electric current flows through the first electrode in the second state of operation, heat is generated in accordance with Joule's first law and the moisture-sensitive element is thereby heated by heat conduction. As the temperature of the moisture-sensitive element 9 rises, for example by at least 50K, or in an embodiment by more than 70K, trapped water and contaminant molecules are liberated, and the creep is reduced or even annulled.

According to the invention, the first electrode 5 is used to heat the moisture-sensitive element 9. Because of the switching of the state of operation of the first electrode, the heat can be generated directly in the first electrode 5. As the heat is realized in the direct vicinity of the moisture-sensitive element 9, the moisture-sensitive element 9 is heated more efficiently compared to the prior art heating solutions, in which the heating devices are arranged further away. In comparison to external or further remotely arranged heating devices, the heat generated does not need to traverse additional layers of the sensor 1, such as silicon dioxide (SiO2) passivation layer having low thermal conductivity, of around 1.5 W/(m·K). Consequently, the current density necessary to heat the moisture-sensitive element 9 to a required temperature can be kept comparatively low. By keeping the current density comparatively low, in particular below 4 kA/mm², the risk of damage to components of the sensor 1 and of electro-migration is also reduced.

At the same time, the heating can also remove volatile organic compounds (VOC) and contamination gases such as ammonia (NH3), hydrogen chloride (HCl), nitrogen dioxide (NO2), or sulfur dioxide (SO2), which, when present in the moisture-sensitive element 9, corrode the electrodes and falsify the sensing. The second state of operation can thus serve to both decontaminate and de-condensate the moisture-sensitive layer.

The heating performance of the electrode 5 is determined by the total electrode resistance R, which in turn is determined by electrical resistivity of the electrode material, the width W1 of the electrode 5, the deposited thickness of the electrode 5, and the total length of the electrode along the serpentine shape. The above-described dimensions and structural arrangements of the first electrode 5 provide a balance of material costs, heating performance and sensing element 3 sensitivity in the second state of operation.

The ASIC 11, in an embodiment, includes a control device configured to control the switching of the switching device M, the sensing of the capacitance in the first state of operation, and the flowing of current I₁ through the first electrode 5 in the second state of operation. The control device is a controller including a processor connected to a non-transitory computer readable medium. A plurality of program instructions are stored on the non-transitory computer readable medium that, when executed by the processor, perform the functions of the control device described herein. The controller may be distinct from the switching device M.

In a variant embodiment, the control device controls the switching of the switching device M periodically, that is, after a predetermined amount of time has elapsed. For example, a predetermined amount of time can be set to ten hours for the first state of operation and for one hour in the second state of operation. Thus, after every ten hours of humidity sensing, the moisture-sensitive element 9 is heated for one hour to remove counteract creep and remove contaminants. Alternatively, or in addition, the control device could be configured to control the switching based on capacitance measurement values, for example, when the measured capacitance values fall below or exceed predetermined range of expected capacitance values.

In one aspect of the humidity sensor, the control device can be configured to control the switching of the switching device automatically based on a predetermined condition, in particular periodically or according to a threshold value related to the detected electric property of the moisture-sensitive element. In this configuration, the humidity sensor can have an automatic self-maintenance and/or self-calibration functionality that can be triggered for example after a predetermined amount of time has elapsed, or for example, when predetermined electric property values have been exceeded, reached, or repeatedly achieved.

In another variant, the control device can be configured to control the switching of the switching device only upon external command or input. For example, a user activates the switching of the switching device when a maintenance is desired or scheduled. When a control device is included in the sensor, the heating function and/or the switching between states of operation can be operated autonomously.

In one aspect of the humidity sensor, the control device can be an integrated circuit (IC) or microchip, in particular an application-specific integrated circuit (ASIC). Thus, the control device can be integrated together with the sensing element to form a microsensor, having particularly small size.

In one aspect of the humidity sensor, the first electrode can be formed directly on the IC. In this configuration, the microsensor can be manufactured by forming the sensing element as a microelectromechanical system (MEMS) on the microchip, using for example a MEMS process using photolithography patterning. Photolithography can be advantageous for the patterning of the electrode to realize the serpentine shape, without needing an extra process step.

FIG. 2 shows a first electrode 5′ of a humidity sensor according to a second embodiment of the invention. The humidity sensor of the second embodiment of the invention differs from the first embodiment of the invention only with respect to the structural arrangement of the electrodes. FIG. 2 shows a first electrode 5′ and a projection 7p′ of a second electrode 7′, in a view corresponding to the view of FIG. 1B. The first electrode 6 comprises contact pads 25′, 27′. An internal contact pad 19′, connected via the second electrode 7′, is connected by a metal trace 21′ to an ASIC input pad 23′.

In the second embodiment, the second electrode 7′ has a circular shape, and the projection 7p′ of the second electrode 7′ on the plane is circular. The serpentine shape of the first electrode 5′ is arranged to be adapted to the circular outline 7p′. In particular, corner zones Z are omitted from the electrode design, in comparison to a rectangular design such as the one of FIG. 2. In addition, the width W2 of the serpentine electrode 5′ are smaller, for example 10% to 40% smaller, than the width W1 of the first electrode 5 of the first embodiment. In this embodiment having first and second electrodes with overall circular area, the overall compactness of the humidity sensor including the packaging can be advantageously improved. In other embodiments of the invention, the first electrode can be patterned in a shape having rounded corners or soft corners, in particular in a way to avoid sharp or U-shaped corners. For example, the first electrode can have a spiral shape, or a labyrinthine shape, or an annular shape, or even an octagonal shape. By avoiding sharp or U-shaped corners, material degrading electrical phenomena such as electron migration can be reduced or avoided, and the durability of the electrode prolonged.

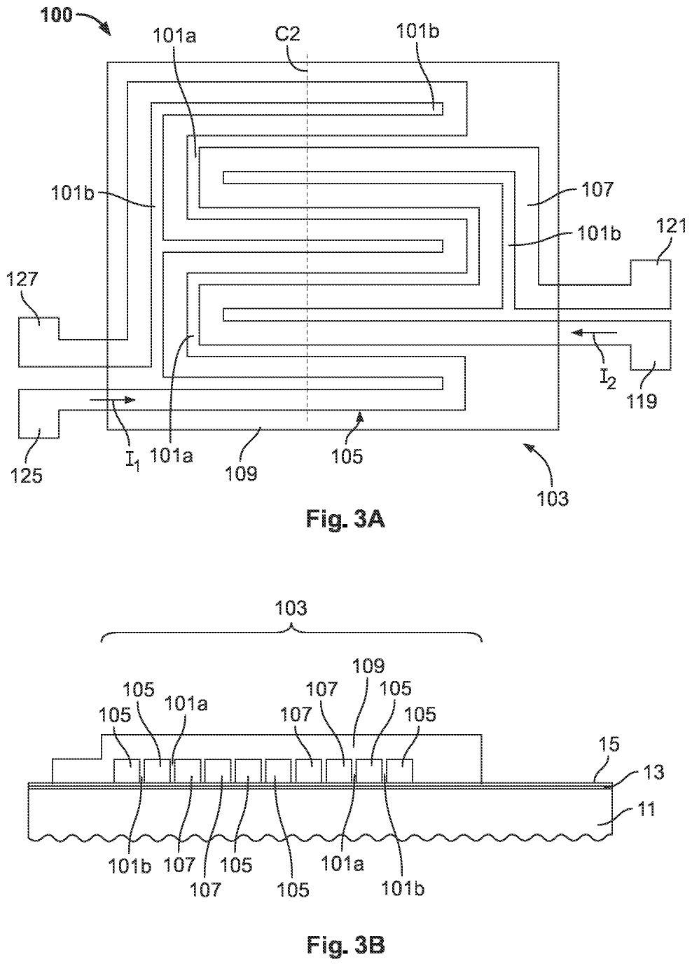

FIG. 3A shows the electrodes of a humidity sensor according to a third embodiment of the invention. The humidity sensor 100 of the third embodiment of the invention is not a sandwich-type sensor but instead uses interdigitated electrodes in the sensing element.

The humidity sensor 100 of FIG. 3A comprises two interdigitated electrodes 105, 107 covered by a moisture-sensitive element 109, for example of the same dielectric material as the moisture-sensitive element 9. The first electrode 105 comprises at its opposed electrode extremities respective the contact pads 125, 127, and the second electrode 103 also at its opposed electrode extremities respective the two contact pads 119, 121. In this embodiment, the contact pad pairs 125, 127 and 119, 121 are located on opposing sides of the interdigitated electrode but could also be provided on the same side. The interdigitated electrodes 105, 107 are separated by a gap 101a. The two conductive traces of the electrode 105 extending from respective contact pads 125, 127 are separated by the gap 101b. Correspondingly, the two conductive traces of the electrode 107 extending from respective contact pads 119, 121 are also separated by the gap 101b. The contact pads 119, 121, 125, 127 are connected to ASIC input pads of the ASIC 11, which is comprises a switching device M and control device, as already described with respect to the first embodiment.

FIG. 3B shows a cross-sectional side view of the humidity sensor 100 along the line C2 of FIG. 2. FIG. 3B shows, like in the first and second embodiment, the electrodes 105, 107 and the moisture-sensitive element 109 are deposited on an ASIC 11. The ASIC 11 comprises the passivation layer 13 already described, and the electrodes 105, 107 are deposited on the surface 15 of the passivation layer 13. The passivation layer 13 provides an insulation function. The moisture-sensitive element 109 is deposited over the electrodes 105, 107 such that it entirely fills the gap 101a and the gaps 101b. The electrodes 105, 107 and the moisture-sensitive 109 form a sensing element 103 for the sensing of a capacitance.

In this embodiment, the moisture-sensitive element 109 is directly exposed to the environment to be sensed, rather than being separated by a porous electrode 7. Both electrodes 105, 107 are metallic and non-porous. According to the invention, one or both can be configured to operate in a second state of operation in which the moisture-sensitive element 9 is heated by an electric current flowing through one or each one the electrodes 105, 107.

Thus, in this embodiment, both the first 101 and the second electrode 103 can be operated in the second state of operation to heat the moisture-sensitive element 109. As direct electrical current can flow through both electrodes, simultaneously or alternatingly, the heated surface of the moisture-sensitive element 109 is increased. For example, the moisture-sensitive element 109 is heated by the current I₁ flowing through the electrode 105 and by the current I₂ flowing through the electrode 107. Thus, the heating efficiency is improved, leading to improved decontamination and decondensation performance.

What is claimed is:

1. A humidity sensor, comprising:
a sensing element including a first electrode, a second electrode, and a moisture-sensitive element, a portion of the moisture-sensitive element is sandwiched between the first electrode and the second electrode; and
a switching device switching the first electrode between a first state of operation and a second state of operation, the first electrode senses an electric property of the moisture-sensitive element in the first state of operation, the first electrode heats the moisture-sensitive element with an electric current through the first electrode in the second state of operation.

2. The humidity sensor of claim 1, wherein the first electrode has a pair of electrical contact points at a same electric potential in the first state of operation and at a different electric potential in the second state of operation.

3. The humidity sensor of claim 1, wherein the first electrode has a serpentine shape.

4. The humidity sensor of claim 3, wherein a surface along the serpentine shape is in direct contact with the moisture-sensitive element.

5. The humidity sensor of claim 3, wherein a gap between a plurality of windings of the serpentine shape is smaller than a width of the first electrode.

6. The humidity sensor of claim 1, further comprising a control device controlling:
a switching of the switching device; and/or
a flow of the electric current through the first electrode.

7. The humidity sensor of claim 6, wherein the control device controls the switching of the switching device automatically based on a predetermined period or according to a threshold value related to the electric property of the moisture-sensitive element.

8. The humidity sensor of claim 6, wherein the control device is an integrated circuit or a microchip.

9. The humidity sensor of claim 8, wherein the first electrode is formed directly on the integrated circuit.

10. The humidity sensor of claim 9, wherein the integrated circuit has a passivation layer, the first electrode is formed on the passivation layer.

11. The humidity sensor of claim 10, wherein the passivation layer has a silicon nitride layer and/or a silicon dioxide layer.

12. The humidity sensor of claim 1, wherein the first electrode has a layer of a material selected from: tungsten, chrome, titanium, titanium nitride, manganese, nickel-chrome alloy, and carbon.

13. The humidity sensor of claim 12, wherein the first electrode has a noble metal layer formed on the layer of the material.

14. The humidity sensor of claim 1, wherein the switching device switches the second electrode between the first state of operation and the second state of operation.

15. The humidity sensor of claim 1, wherein the second electrode is an organic material.

16. The humidity sensor of claim 1, wherein the second electrode is a material selected from: an Intrinsically Conductive Polymer (ICP), a phenolic resin, a vinyl polymer, a rubber, a fluoropolymer, a polyolefin, a polyester, a polyanhydride, a silicone, a biopolymer, an inorganic polymer, or a combination thereof.

17. The humidity sensor of claim 1, wherein the second electrode is doped with a plurality of electrically conductive particles.

18. The humidity sensor of claim 1, wherein the second electrode is porous.

19. The humidity sensor of claim 1, wherein the second electrode is metallic and has a plurality of through-holes exposing the moisture-sensitive element.

20. The humidity sensor of claim 1, wherein the electric property is a capacitance of the moisture-sensitive element and the electric current is a direct current.
